(19) United States
(12) Patent Application Publication
(10) Pub. No.: US 2026/0008033 A1
(43) Pub. Date: Jan. 8, 2026

(54) METHOD FOR THE PRODUCTION OF DIHYDROGEN USING OXIDIZED NANODIAMONDS AS PHOTOCATALYSTS

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris Cedex 16 (FR); UNIVERSITE DE STRASBOURG, Strasbourg (FR)

(72) Inventors: Jean-Charles ARNAULT, Gif-Sur-Yvette Cedex (FR); Hugues GIRARD, Gif-Sur-Yvette (FR); Valérie KELLER, Strasbourg Cedex 2 (FR); Clément MARCHAL, Strasbourg Cedex 2 (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris Cedex 16 (FR); UNIVERSITE DE STRASBOURG, Strasbourg (FR)

(21) Appl. No.: 18/881,150

(22) PCT Filed: Jul. 12, 2023
(86) PCT No.: PCT/FR2023/051083

§ 371 Date: Jan. 3, 2025

(30) Foreign Application Priority Data
Jul. 13, 2022 (FR) FR2207220

(51) Int. Cl. B01J 21/18; B01J 35/23; B01J 35/39; B01J 35/45; B01J 37/14; B01J 37/34

(52) U.S. Cl. CPC B01J 21/18; B01J 35/23; B01J 35/39; B01J 35/45; B01J 37/14; B01J 37/343

(57) ABSTRACT

A method for producing dihydrogen by photodissociation of water, may include bringing an aqueous solution in contact with oxidized nanodiamonds under solar, natural, or artificial illumination (or light). The oxidized nanodiamonds may have an oxygen/carbon ratio of at least 5% atomic, determined by XPS without previous treatment of the oxidized nanodiamonds. The method may further include preparing the oxidized nanodiamonds by subjecting nanodiamonds to an oxidizing treatment. The oxidizing treatment may include annealing at a temperature of 500° C.±50° C. for a duration in a range of from 1 to 5 hours under an oxygenated atmosphere.

### TECHNICAL FIELD

The present invention relates to the general technical field of nanomaterials and, more particularly, the nanomaterials for photocatalysis and in particular for the production of dihydrogen (H₂) by photo-induced dissociation of water, a method known by the expression “water splitting”.

Indeed, the present invention proposes using as photocatalysts nanoparticles of oxidized diamond or nanodiamonds. In other words, the present invention proposes a method for producing dihydrogen from water, comprising a step of placing an aqueous solution in contact with nanoparticles of oxidized diamond under light irradiation. The present invention also relates to a specific photocatalytic composition comprising oxidized nanodiamonds and at least one other (photo) catalyst.

### PRIOR ART

Because, on the one hand, of the increasing demand for energy and, on the other hand, of the reduction in fossil fuels, such as coal, petroleum and natural gas, particular interest has been shown in dihydrogen (H₂) which has several advantages with respect to fossil fuels.

First of all, the combustion of H₂ only produces water (H₂O) contrary to fossil fuels, the combustion of which emits carbon dioxide (CO₂) thus participating in global warming.

Moreover, to avoid the production of H₂ from natural gas which also leads to the production of CO₂, alternative, renewable solutions less harmful to the environment have been proposed among which is the production of H₂ by photocatalysis of water. In this method, the dissociation of the water induced by the photons i.e. under light irradiation produces H₂ that can be used directly for combustion, in fuel cells, for uses in the methods of chemistry or petrochemistry or stored in particular in liquid form.

Methods for photocatalytic production of H₂ are known from the prior art.

Photocatalysis is based on the principle of activation of a semiconductor or of a set of semiconductors such as a photocatalyst, using the energy provided by irradiation.

A semiconductor is characterized by its band gap between the valence band and the conduction band that is specific to it. Any photon having an energy greater than its band gap can be absorbed by the semiconductor. On the contrary, any photon having an energy lesser than its band gap cannot be absorbed by the semiconductor.

Photocatalysis can be defined as the absorption of a photon, the energy of which is greater than the band gap width, which induces the formation of an electron-hole pair in the case of a semiconductor. There is therefore the excitation of an electron at the conduction band and the formation of a hole on the valence band. This electron-hole pair allows the formation of free radicals that either react with the compounds present in the medium such as H₂O, in order to initiate redox reactions, or recombine according to various mechanisms.

It is therefore worth having high-performing photocatalysts for the production of H₂ by dissociation of water in particular by using sunlight, which must:
a) have a band structure suitable for the generation of charge carriers which will allow oxidation and reduction reactions on its surface for the production of H₂ from protons coming from the oxidation of the water by the photogenerated holes,
b) have the best possible absorption of the sunlight and a low recombination of the photogenerated charge carriers to guarantee an optimal efficiency of the photocatalytic reaction,
c) be available in large quantities, at a low cost and respectful of the environment, which greatly limits the use of metal particles like particles of platinum, of oxides of rare earths, etc., and
d) remain effective during operation.

To take into account these constraints, it is therefore of interest to develop photocatalysts that are, on the one hand, nanometric to access a larger total surface area and, on the other hand, semiconductor to photogenerate charges, with positions of conduction and valence bands, the energy levels of which are adapted to the oxidation of water and to the reduction of protons, and the band-gap energy of which is adapted to the wavelengths of visible light.

In the literature, a certain number of materials have already been identified as photocatalysts for the production of H₂ by dissociation of water. Titanium dioxide (TiO₂) having an anatase structure is certainly the semiconductor the most studied, because of certain properties favorable to this reaction, in particular (i) its photostability in water, (ii) the suitable position of its valence band easily allowing to initiate the first step of oxidation of the water (H₂O->2H⁺+½O₂+2e⁻), (iii) an acceptable charge-carrier behavior, (iv) its non-toxicity and (v) its relatively moderate cost, compared to other types of photocatalysts.

Nevertheless, the main limitation of TiO₂ lies in its large band gap (3.1-3.2 eV), requiring an activation by wavelengths lower than 400 nm (range of the UVs), which considerably restricts the use of natural sunlight which consists of approximately 40% visible photons, not energetic enough and thus ineffective to activate the TiO₂. Moreover, because of the difficulty of carrying out the half-reaction of reduction into hydrogen (2H⁺+2e⁻->H₂), noble metals, rare and expensive, are often added as co-catalysts in order to carry out the catalytic reduction into dihydrogen.

Numerous strategies have already been implemented to overcome these limitations such as the modifications of composition, of morphology, of chemical structure, of size, of surface area, of deposition of metal nanoparticles developing surface plasmonic properties, as well as the coupling (formation of heterojunctions) with other semiconductors, allowing to induce favorable electronic, optical or chemical effects.

The nanomaterials containing diamond have also been proposed as photocatalysts. They are often used in the form of hybrids or of composites.

Thus, in 2016, Lin et al propose nanocrystals of copper (I) oxide of the p type integrated into nanodiamonds for broad-spectrum photocatalytic hydrogen evolution [1].

The international application WO 2016/193464 A1 describes the use of a photocatalytic composite comprising at least one semiconductor compound having a band gap ranging from 2 to 5 eV and nanoparticles of diamond, the surface of which is advantageously hydrogenated [2].

In other composites of the prior art useful not for the photocatalysis of water but for the depollution of water, nanodiamonds optionally doped with boron are implemented with graphitic carbon nitride (or g-C3N4) [3], optionally in association with silver nitrate (AgNO₃) [4].

A single study in the literature reports an effect of production of dihydrogen by dissociation of water with nanodiamonds alone [5]. However, in this work, a pulsed laser having a wavelength of 532 nm, having a high power (80 mJ/pulse), is used. Nothing suggests that such a material could be used for the dissociation of water by using the spectrum of sunlight, the power of which is much lower. Moreover, it is clear from [5] that the use of nanodiamonds having a hydrogenated surface is preferred since the hydrogenation considerably increases the quantum efficiency, which suggests that the sites with a hydrogen termination function as reservoirs of electrons.

The inventors set the goal of proposing photocatalysts allowing to produce H₂ from water by using sunlight as a source of photons, without requiring the use of co-catalysts like noble metals or treatments complicated to implement such as a hydrogenation.

### DESCRIPTION OF THE INVENTION

The present invention allows to reach the goal that the inventors have set. Indeed, the latter have shown that it is possible to dissociate, under light irradiation, water in order to produce dihydrogen by using, as photocatalysts, oxygenated diamond nanoparticles.

On the one hand, the oxidized nanodiamonds can be used without addition of other photocatalysts or co-catalysts such as metal particles. In other words, in the method according to the invention, the oxidized nanodiamonds can be used as the only photocatalysts.

As a reminder, diamond is a wide-band semiconductor (5.5 eV) that is therefore theoretically not suitable for the absorption of visible light. However, in the form of nanoparticles, its properties of absorption of light are modified either by optical effects related to the nanometric dimensions or by the incorporation of structural defects during their synthesis.

Moreover, the works of the inventors show that the effect is present for a nanodiamond having an oxidized surface. According to its surface chemistry, the band diagram of the nanodiamond changes. A diamond surface saturated with hydrogen has conduction and valence band edge electrochemical potentials more negative than a diamond surface saturated with oxidized functions. This is illustrated in FIG. 1 for bulk diamond.

Thus, the most reductive structure (i.e. hydrogenated diamond) is not the most favorable to allowing the production of H₂. This is counter-intuitive for a person skilled in the art. On the contrary, the inventors have shown that oxidized nanodiamonds must be used to maximize the production of dihydrogen.

More particularly, the present invention relates to the use of oxidized nanodiamonds as photocatalysts for the production of dihydrogen. This production of dihydrogen is obtained under solar, natural or artificial illumination (or light).

In other words, the present invention relates to a method for producing dihydrogen by photodissociation of water, comprising at least one step of bringing an aqueous solution in contact with oxidized nanodiamonds under light irradiation i.e. under solar, natural or artificial illumination (or light).

The expressions “photodissociation of water” “(photo) dissociation of water under light irradiation”, “photocatalysis of water” and “(photo) catalysis of water under light irradiation” are equivalent and usable interchangeably in the present manuscript.

Likewise, the expressions “under solar, natural or artificial illumination”, “under solar, natural or artificial light” and “under solar, natural or artificial irradiation” are equivalent and usable interchangeably in the present manuscript.

The present invention implements nanodiamonds i.e. diamond in the form of nanoparticles. These nanodiamonds can be obtained from natural diamond or from synthetic diamond. A synthetic diamond is typically obtained by high-pressure high-temperature (HPHT) synthesis or by chemical vapor deposition (CVD).

They can more particularly be obtained (i) by grinding of bulk diamond, natural or synthetic; (ii) by detonation in particular as described in the international application WO 2016/193464 A1 [2], (iii) directly by HPHT growth or CVD.

The average size of the diamond nanoparticles implemented in the present invention is between 1 and 500 nm, namely between 1 and 200 nm, in particular between 2 and 100 nm and, more particularly, between 5 and 50 nm.

In a specific embodiment, the diamond nanoparticles implemented in the present invention can be doped, in particular doped with nitrogen or with phosphorus (doping of the n type) or doped with boron (doping of the p type).

As explained above, the nanodiamonds implemented in the present invention are oxidized i.e. oxidized on the surface. In other words, the surface of the oxidized nanodiamonds has more oxygen atoms than the surface of the non-oxidized nanodiamonds.

Typically, the oxidized nanodiamonds implemented in the invention have an oxygen/carbon ratio of at least 5% atomic determined by XPS (photoemission spectroscopy) without previous treatment of the oxidized nanodiamonds such as an annealing to dehydrate.

To obtain oxidized nanodiamonds, these nanodiamonds must be subjected to an oxidizing treatment.

The oxidizing treatment aims to oxidize the surface of the nanodiamonds by fixing and/or by introducing, on the latter, groups, identical or different, rich in oxygen i.e. groups, identical or different, comprising at least one oxygen atom. In the present invention, a group comprising at least one oxygen atom is in particular chosen from the group consisting of a carboxylic group (—C(═O)OH), a hydroxyl group (—OH), a carbonyl group (—C(═O)—) and a percarbonic group (—C(═O)—O—OH).

Such an oxidizing treatment is based on two broad types of surface modifications based on:
physical treatments such as a plasma treatment (radiofrequencies, microwaves), a UV treatment, an X or gamma-ray treatment, a treatment by irradiation with electrons and heavy ions, wherein these various physical treatments can be carried out under CO₂ or under an oxygenated atmosphere such as, for example, under air, under O₂, under O₂/argon or under ozone such as, for example, a UV treatment under ozone;
chemical treatments such as a treatment with alcoholic potash, a hot or cold treatment with a mixture of sulfuric acid (H₂SO₄) and nitric acid (HNO₃), a treatment with a mixture of sulfuric acid (H₂SO₄) and hydrogen peroxide (H₂O₂) also known by the name “piranha mixture”, a treatment with a mixture of H₂O₂ and iron also known by the name “Fenton's reagent”, a treatment with a strong acid (HCl, H₂SO₄, HNO₃, HClO₄), a treatment with soda, a treatment with a strong oxidizing agent (KMnO₄, K₂Cr₂O₇, KClO₃ or CrO₃ in hydrochloric acid, sulfuric acid or nitric acid), a treatment with molten salts (KNO₃), a treatment with ozone and a heat treatment under CO₂ or under an oxygenated atmosphere such as, for example, under air, under O₂, under O₂/argon or under ozone.

The oxidizing treatments as described above can be carried out either at atmospheric pressure and/or at ambient temperature (Tamb) or at a pressure greater than the atmospheric pressure and/or at a temperature greater than the ambient temperature (case in particular of the heat treatments). “Ambient temperature” means a temperature of approximately 23° C. (i.e. 23° C.±5° C.).

Advantageously, the oxidizing treatment implemented is a heat treatment under an oxygenated atmosphere such as, for example, under air, under O₂, under O₂/argon or under ozone. The latter involves, advantageously, an annealing at a temperature of 500° C.±50° C. for a duration between 1 h and 5 h and in particular between 1 h and 3 h, under an oxygenated atmosphere such as, for example, under air, under O₂, under O₂/argon or under ozone, and in particular under air. The experimental part below illustrates such a heat treatment. Consequently, the method according to the invention can present a preliminary step of preparation of the oxidized nanodiamonds involving subjecting nanodiamonds to an oxidizing treatment as defined above. Typically, once the oxidizing treatment has been carried out, the oxidized nanodiamonds are placed in suspension again. This involves subjecting the oxidized nanodiamonds to a sonication then to a centrifugation whereby a colloidal suspension of oxidized nanodiamonds is obtained.

Before the sonication, the oxidized nanodiamonds are brought in contact with an aqueous solution. Such a solution has, as a solvent, a water-based solvent thus justifying the name of aqueous solution. “Water” means, in the context of the present invention, tap water, deionized water, distilled water or ultra-pure water (18.2 MΩ·cm at 25° C.).

Typically, the quantity of oxidized nanodiamonds used during the bringing in contact with the aqueous solution before the sonication is between 1 g/l of aqueous solution and 50 g/l of aqueous solution, namely between 10 g/l of aqueous solution and 40 g/l of aqueous solution and, in particular, approximately 30 g/l of aqueous solution (i.e. 30 g/l±5 g/l).

The sonication step is carried out at a temperature between 4° C. and 20° C., namely between 6° C. and 15° C. and, in particular, of approximately 10° C. (i.e. 10° C.±2° C.). Advantageously, a thermostated bath is used during the sonication step. Moreover, the sonication step lasts between 15 min and 3 h, namely between 30 min and 2 h and, in particular, approximately 1h (i.e. 1 h±15 min).

The step of centrifugation is implemented to separate the colloidal suspension of oxidized nanodiamonds corresponding to the supernatant obtained after the step of centrifugation of the clusters of oxidized nanodiamonds forming the pellets obtained after the step of centrifugation. To do this, the centrifugation step is carried out at a value between 1500 g and 4000 g, namely between 2000 g and 3000 g and, in particular, of approximately 2400 g (i.e. 2400 g±200 g).

The centrifugation step is carried out at a temperature between 4° C. and 20° C., namely between 6° C. and 15° C. and, in particular, of approximately 10° C. (i.e. 10° C.±2° C.). Moreover, the centrifugation step lasts between 15 min and 2 h, namely between 30 min and 1 h and, in particular, approximately 40 min (i.e. 40 min±5 min).

The oxidized nanodiamonds are brought in contact during step a) with an aqueous solution as defined above.

In a specific embodiment, the solvent of the aqueous solution implemented during step a) only comprises water i.e. this solvent consists of water and in particular of ultra-pure water (18.2 MΩ·cm at 25° C.).

Typically, the quantity of oxidized nanodiamonds used during the placement in contact with the aqueous solution is between 1 mg/l of aqueous solution and 1 g/l of aqueous solution, namely between 5 mg/l of aqueous solution and 500 mg/l of aqueous solution, in particular, between 10 mg/l of aqueous solution and 50 mg/l of aqueous solution and, more particularly, approximately 12.5 mg/l of aqueous solution (i.e. 12.5 mg/l±1 mg/l).

The contact between the aqueous solution and the oxidized nanodiamonds can be carried out under stirring and/or under inert gas such as argon, nitrogen, helium or one of their mixtures, in continuous or discontinuous flow. Advantageously, this placement in contact is carried out under stirring and under a continuous flow of nitrogen.

Typically, the contact between the aqueous solution and the oxidized nanodiamonds is carried out at a temperature between 5° C. and 80° C., in particular between 15° C. and 50° C. and, more particularly, at ambient temperature.

During the contact, the oxidized nanodiamonds can be in the form of a suspension. Alternatively, during the contact, the oxidized nanodiamonds can be supported.

Any type of support conventionally used to retain photocatalysts in a method for dissociation of water under light irradiation is usable in the context of the present invention. Illustrative examples include 2D supports such as, for example, textile sheets and in particular textile sheets made of optical fibers; surface coatings such as, for example, paints; and dense or porous 3D supports such as, for example, foams or honeycombs.

The contact between the oxidized nanodiamonds and the aqueous solution is carried out under light irradiation. This light irradiation can be natural (sunlight) or artificial in particular via an irradiation device such as a lamp, a UV lamp, a visible lamp, a UV-visible lamp, an IR lamp, an excimer lamp, an LED, a laser, a laser diode or a supercontinuum fibered source. It is obvious that, in the context of an artificial solar irradiation, the irradiation device used reproduces the spectrum of sunlight and the power of the latter.

Advantageously, the irradiation device has an irradiance between 25 mW/cm² and 150 mW/cm² and in particular of approximately 53.5 mW/cm²±5 mW/cm². In other words, “under light irradiation” means under natural or artificial solar illumination (or light).

The radiation implemented during this light irradiation can be a UV radiation (wavelength from 200 to 400 nm), a visible radiation (wavelength from 400 to 800 nm) or a near-IR radiation (wavelength from 800 to 1200 nm) and one of their combinations.

Advantageously, the light irradiation implemented in the method of the invention is a natural light irradiation i.e. a natural solar illumination (or light).

In the context of the present invention, the aqueous solution can further contain a sacrificial agent. Typically, the sacrificial agent implemented in the invention is an electron donor agent, capable of being oxidized by the dioxygen formed during the reaction of photodissociation of the water and effectively allows to improve the yield of the production of H₂.

The sacrificial agent implemented in the method according to the invention is typically chosen from the group consisting of the amines and the alcohols and more particularly from the group consisting of methanol, ethanol, triethanolamine (TEOA) and one of their mixtures. Advantageously, the sacrificial agent used in the context of the method according to the invention is TEOA or methanol.

When present, the sacrificial agent is present in a quantity between 0.05% and 50% by volume relative to the volume of aqueous solution and, in particular, between 0.1% and 1% by volume relative to the volume of aqueous solution.

In a specific embodiment, the oxidized nanodiamonds are the only photocatalysts implemented in the method.

Alternatively, in another specific embodiment, the oxidized nanodiamonds are used with at least one other element chosen from the group consisting of photocatalysts, catalysts, adsorbents and their combinations. Thus, the oxidized nanodiamonds can be associated with at least one other photocatalyst of the type inorganic, molecular (quantum dots and clusters) or organic (colorants) photocatalyst in a heterojunction, and/or with at least one catalyst of the type metal, inorganic or molecular (quantum dots and clusters) catalyst and/or with at least one adsorbent such as activated carbon or the MOFs (for “Metal Organic Frameworks”) that improve the adsorption of the species and the transfer of the charges, wherein these adsorbent materials can also have semiconductor properties like certain MOFs. In this alternative, the oxidized nanodiamonds and the other element(s) chosen from the group consisting of photocatalysts, catalysts, adsorbents and their combinations form a catalytic composition. Advantageously, this catalytic composition does not comprise any platinum or other noble metal.

Any photocatalyst of the semiconductor or molecular type, known to a person skilled in the art and used in the methods for photodissociation of water to produce H₂, is usable in the context of the present invention.

However, in a specific embodiment of the method according to the invention, the photocatalyst associated with the oxidized nanodiamonds does not comprise graphitic carbon nitride.

Advantageously, the photocatalyst(s) implemented with the oxidized nanodiamonds is/are chosen from the group consisting of the transition metals, the derivatives of transition metals, the metal carbides, the metal nitrides, the metal oxides, the metal sulfides. In particular, the photocatalyst(s) implemented with the oxidized nanodiamonds is/are chosen from the group consisting of the oxides of transition metals and the sulfides of transition metals. In particular, the photocatalyst(s) implemented with the oxidized nanodiamonds is/are chosen from the group consisting of TiO₂, TiO₂—B (in the form of a titanate sheet), ZnO, WO₃ and Fe₂O₃.

When used with oxidized nanodiamonds, the photocatalyst(s), the catalyst(s) and/or the adsorbent(s) can be in dispersed form and in particular in the form of nanoparticles. The average size of these nanoparticles is between 1 and 1000 nm, namely between 2 and 200 nm, in particular, between 3 and 100 nm, more particularly, between 4 and 50 nm and, especially, between 5 and 20 nm.

Alternatively, the photocatalyst(s), the catalyst(s) and/or the adsorbent(s) can be used in aggregated form.

The present invention also relates to a photocatalytic composition used in the method according to the invention. This photocatalytic composition comprises oxidized nanodiamonds and at least one other element chosen from the group consisting of photocatalysts, catalysts, adsorbents and their combinations, said photocatalytic composition not comprising any graphitic carbon nitride.

In the photocatalytic composition according to the invention, the oxidized nanodiamonds are present in a quantity between 0.1 and 80% by weight, namely between 1 and 50% by weight, in particular, between 2 and 30% by weight relative to the quantity of said at least one other element chosen from the group consisting of photocatalysts, catalysts, adsorbents and their combinations.

Other features and advantages of the present invention will also appear upon reading the following examples given for illustrative and non-limiting purposes and referring to the appended drawings.

### BRIEF DESCRIPTION OF THE DRAWINGS

FIG. 1 presents the energy-band diagram of hydrogenated and oxidized diamond compared to other semiconductors [6].

FIG. 2 presents the size distribution by dynamic light scattering (DLS) of oxidized nanodiamonds prepared as described in point I below.

FIG. 3 presents the Fourier-transform infrared absorption spectrum of oxidized nanodiamonds prepared as described in point I below.

FIG. 4 presents the XPS analysis of oxidized nanodiamonds prepared as described in point I below.

FIG. 5 presents the comparison of the average speed of production of H₂ by photocatalytic dissociation of water under artificial solar irradiation in the presence of 10 mg of “Plasma Chem” oxidized nanodiamonds (2 repeatability tests) or of P25 TiO₂ (Evonik), with 1 vol. % of TEOA (sacrificial agent).

FIG. 6 presents the average speed of production of H₂ by photocatalytic dissociation of water under artificial solar irradiation in the presence of 10 mg of “Plasma Chem” oxidized nanodiamonds, according to the concentration of TEOA (sacrificial agent).

FIG. 7 presents the average speed of production of H₂ by photocatalytic dissociation of water under artificial solar irradiation in the presence of 1 vol. % of TEOA (sacrificial agent), according to the concentration of “Plasma Chem” oxidized nanodiamonds.

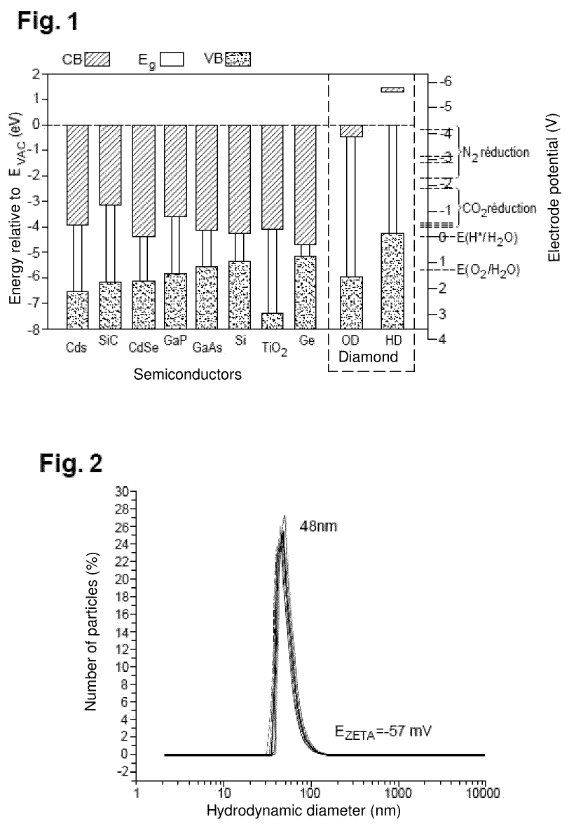

### DETAILED DISCLOSURE OF SPECIFIC EMBODIMENTS

### I. Preparation of the Oxidized Nanodiamonds.

The diamond nanoparticles used were synthesized by detonation and obtained from the company PlasmaChem (Germany).

The diamond nanoparticles were, first of all, oxidized by annealing under air, at atmospheric pressure, according to the following protocol:
2 crucibles each filled with 200 mg of untreated nanoparticles are placed at the center of a tube furnace;
the temperature of the furnace is brought from Tamb to 200° C. with a temperature ramp of 20° C./min then the nanoparticles are maintained at 200° C. for 15 min;
the temperature of the furnace is brought from 200° C. to 500° C. with a temperature ramp of 30° C./min then the nanoparticles are maintained at 500° C. for 1 h 30;
the two crucibles are then removed “while hot” using tongs and placed at Tamb to cool the nanoparticles as quickly as possible and thus stop the annealing;
when the nanoparticles have come back to Tamb, they are weighed. The loss generally observed is approximately 50% of the initial mass.

The nanoparticles are then placed in suspension according to the following protocol:
100 mg of oxidized nanoparticles are placed in a centrifuge tube of the Falcon 15 mL type;
3 mL of ultra-pure water (18.2 MΩ·cm) are added;
the temperature of the solution is brought to 10° C. in a thermostated bath;
the solution is then subjected to a sonication using a Cup Horn device (Bioblock Scientific 750 W, amplitude 60%, cycle 1 sec ON/1 sec OFF, duration 60 min), while maintaining the temperature at 10° C.,
after the sonication, the solution is then centrifuged (2400 g, 40 min) in order to remove the largest clusters,
immediately after the centrifugation, the supernatant containing the nanoparticles in colloidal suspension is removed by pipetting (approximately 2.5 mL of the initial 3 mL),
the suspension is then kept in a plastic bottle at ambient Tamb, sheltered from light. This conservation can be carried out over long periods i.e. greater than 1 year.

The concentration of nanoparticles in the suspension is determined by the drying, at Tamb, for one night, of 100 μl of suspension and the measurement of the mass of the dry residue.

### II. Characterizations of the Oxidized Nanodiamonds.

### II.1. Methods.

Measurement of the hydrodynamic diameter of the objects in suspension by dynamic light scattering (DLS) on 1 ml of suspension at 1 mg of nanoparticles/mL (HORIBA SZ-100 Nanopartica Series).
Measurement of the zeta potential of the objects in suspension by electrophoretic scattering of light on 700 μl of suspension at 1 mg of nanoparticles/ml (HORIBA SZ-100 Nanopartica Series).
Characterization of the surface chemistry of the nanodiamonds in suspension by Fourier-transform infrared spectroscopy: 2 μl of the suspension at 5 mg nanoparticles/ml are evaporated on the ATR crystal of a Bruker Alpha II spectrometer.
Chemical characterization of the nanodiamonds in suspension by XPS and determination of the O/C ratio: 20 μl of the suspension at 1 mg of nanoparticles/ml are evaporated on a silicon substrate coated with 50 nm of gold. The analysis is carried out on a Kratos Analytical Axis Ultra DLD (monochromatized Al Ka source).

### II.2. Results.

As illustrated in FIG. 2, oxidized nanodiamonds have, in suspension, a hydrodynamic diameter of 48 nm±10 nm and a zeta potential of 57 mV±5 mV.

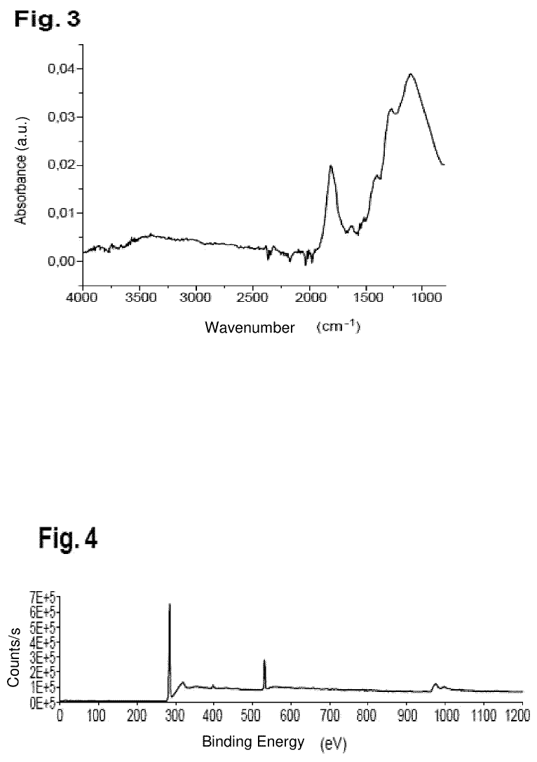

The infrared absorption spectrum of the oxidized nanodiamonds provided in FIG. 3 highlights the presence of C═O bonds (1750 cm⁻¹) probably involved in carboxylic acids, as well as the presence of C—O bonds (1000-1300 cm⁻¹) linked to alcohol functions or esters of surfaces. A shoulder is also noted between 3000 and 3500 cm⁻¹ reflecting the presence of O—H bonds, linked to the carboxylic acids. Indeed, the spectrum is recorded under a dry nitrogen flow, there is therefore no contribution of OH coming from the ambient humidity. Finally, it is important to note the absence of absorption between 2800 and 3000 cm⁻¹, which means the absence of C—H bonds on the surface of the particles.

The XPS analysis highlights the presence of three elements in the oxidized nanodiamonds, namely carbon, oxygen and nitrogen (FIG. 4). The latter is located for the most part in the core of the nanoparticles and comes from the nitrogen explosives used during the synthesis by detonation. The atomic proportions of each element are given in Table 1 below.

TABLE 1

| | |
|---|---|
| Carbon | 87.5 at. % |
| Oxygen | 10.5 at. % |
| Nitrogen | 2 at. % |

### III. Photocatalytic Behavior of the Oxidized Nanodiamonds.

### III.1. Operating Procedure.

To study the photocatalytic behavior of the nanoparticles of oxidized diamond, our experiments involves continuously illuminating the suspension of nanodiamonds (NDs), placed under a continuous flow of inert gas (N₂) with a lamp reproducing the solar spectrum and having a power of 150 W corresponding to an irradiance of 53.5 W/cm² (Spatite Hit 150 G12 8800 K (Art-nr 226224)) of the suspensions of nanodiamonds in the presence of a small proportion of antioxidant/sacrificial agent (triethanolamine or TEOA). The experiments were carried out at Tamb while controlling the temperature of the suspension throughout the photocatalytic test.

The quantification of the dihydrogen produced was carried out, upon stabilization of the production of hydrogen, by an on-line measurement by gas chromatography for 2h. It is thus possible to follow the kinetics of formation of the H₂ produced.

The experimental conditions are the following: photocatalyst (10 or 20 mg) placed in suspension in 800 mL ultra-pure H₂O (mQ), TEOA (0.1 at 1 vol. % TEOA), magnetic stirring 700 rpm, continuous flow N₂ 100 cm³/min, duration of analysis after stabilization 2 h, analytics acquisition every 2.5 min.

### III.2. Results.

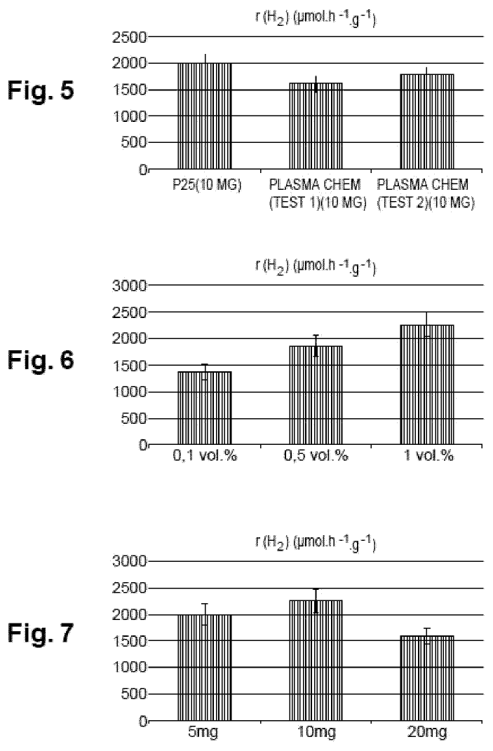

FIG. 5 shows that at an identical concentration, the oxidized nanodiamonds (Plasma Chem) perform just as well as the reference commercial photocatalyst TiO₂ P25 (Evonik).

It is also observed that the production of Hz is linked to the concentration of sacrificial agent (FIG. 6), but in a non-proportional manner, which indeed confirms a production of H₂ by solar photodissociation of water, the TEOA mainly acting as a trap for O₂.

Moreover, the optimal concentration of oxidized nanodiamonds appears to be located near 10 mg, or 12.5 mg/L (FIG. 7).

### BIBLIOGRAPHICAL REFERENCES

[1] Lin et al, 2016, “Nanodiamond-Embedded p-Type Copper (I) Oxide Nanocrystals for Broad-Spectrum Photocatalytic Hydrogen Evolution”, Adv. Energy Mater., vol. 6, 1501865.
[2] International application WO 2016/193464 on behalf of CNRS et al, published 8 Dec. 2016.
[3] Su et al, 2019, “Heterostructured boron doped nanodiamonds@g-C3N4 nanocomposites with enhanced photocatalytic capability under visible light irradiation”, Int J of Hydrogen Energy, vol. 44, 19805.
[4] Patent application CN 110639595 A on behalf of Henan Inst Engineering, published 3 Jan. 2020.
[5] Jang et al, 2012, “Nanodiamonds as photocatalysts for reduction of water and graphene oxide”, Chem. Comm., vol. 48, pages 696-698.
[6] Nebel, 2013, “Photocatalysis: A source of energetic electrons”, Nat. Mater., vol. 12, pages 780-781.

1. A photocatalyst, comprising
an oxidized nanodiamond,
wherein the photocatalyst is suitable to produce dihydrogen, under solar, natural, or artificial illumination or light.

2. A method for producing dihydrogen by photodissociation of water, the method comprising:
bringing an aqueous solution in contact with oxidized nanodiamonds under solar, natural, or artificial illumination or light.

3. The method of claim 2, wherein the oxidized nanodiamonds have an oxygen/carbon ratio of at least 5% atomic, determined by XPS without previous treatment of the oxidized nanodiamonds.

4. The method of claim 2, further comprising:
preparing the oxidized nanodiamonds by subjecting nanodiamonds to an oxidizing treatment.

5. The method of claim 4, wherein the oxidizing treatment consists of an annealing at a temperature of 500° C.±50° C. for a duration in a range of from 1 to 5 hours under an oxygenated atmosphere.

6. The method of claim 2, wherein the contact between the aqueous solution and the oxidized nanodiamonds is carried out under stirring and/or under inert gas.

7. The method of claim 2, wherein the light irradiation is a natural light irradiation.

8. The method of claim 2, wherein the aqueous solution comprises a sacrificial agent.

9. The method of claim 2, wherein the oxidized nanodiamonds are the only photocatalysts implemented.

10. The method of claim 2, wherein the oxidized nanodiamonds are used in a combination comprising a photocatalyst, catalyst, and/or adsorbent.

11. The method of claim 4, wherein the oxidizing treatment comprises an annealing at a temperature of 500° C.±50° C. for a duration in a range of from 1 to 5 hours under an oxygenated atmosphere.

12. The method of claim 2, wherein the contact between the aqueous solution and the oxidized nanodiamonds is carried out under stirring and under a continuous flow of nitrogen.

13. The method of claim 2, wherein the light irradiation comprises a natural light irradiation.

14. The method of claim 2, wherein the aqueous solution comprises triethanolamine.

15. The method of claim 2, wherein the aqueous solution comprises methanol.

16. The method of claim 1, wherein the oxidized nanodiamond has a largest dimension in a range of from 1 and 500 nm.

17. The method of claim 2, wherein the oxidized nanodiamonds have an average largest dimension in a range of from 1 and 500 nm.

18. The method of claim 2, wherein the oxidized nanodiamonds have an average largest dimension in a range of from 1 and 200 nm.

19. The method of claim 2, wherein the oxidized nanodiamonds have an average largest dimension in a range of from 2 and 100 nm.

20. The method of claim 2, wherein the oxidized nanodiamonds have an average largest dimension in a range of from 5 and 50 nm.
